(19) United States
(12) Patent Application Publication
(10) Pub. No.: US 2026/0194357 A1
(43) Pub. Date: Jul. 9, 2026

(54) PRE-PRUNING OF ROUTES FOR OPTIMAL LOGISTICS DISTRIBUTION

(71) Applicant: International Business Machines Corporation, Armonk, NY (US)

(72) Inventors: Deng Xin Luo, Xian (CN); Yu Ying Wang, Xian (CN); Qi Liang Zhou, Xi'An (CN); Yun He Gao, Xian (CN); Zhi Yong Jia, Xian (CN)

(21) Appl. No.: 19/011,569

(22) Filed: Jan. 6, 2025

(51) Int. Cl. G01C 21/34; G06Q 10/0835

(52) U.S. Cl. CPC G01C 21/3461; G01C 21/3492; G06Q 10/08355

(57) ABSTRACT

An example operation includes one or more of extracting multi-dimensional features of a set of travel routes between geographic locations, determining a first subset of travel routes that are valid and a second subset of travel routes that are invalid, among the travel routes based on execution of a first machine learning model on the multi-dimensional features, removing the second subset of travel routes from the travel routes to generate a pruned set of travel routes, determining an optimal travel route for a transport among the pruned set of travel routes based on execution of a model optimization for a transportation network model that includes the pruned set of travel routes, and sending an instruction to utilize the optimal travel route to a computer associated with the transport.

### BACKGROUND

The process of optimizing a transportation network between manufacturers, distribution centers, dealers, and other locations is a common yet complex problem. The process typically includes selecting a location of a distribution center (DC), planning transportation routes to and from the distribution center, determining the type of transportation, etc. Often, multiple industries are involved, such as vehicles transportation, foods transportation, etc.

### SUMMARY

One example embodiment provides a method that may include one or more of extracting multi-dimensional features of a set of travel routes between geographic locations, determining a first subset of travel routes that are valid and a second subset of travel routes that are invalid, among the travel routes based on execution of a first machine learning model on the multi-dimensional features, removing the second subset of travel routes from the travel routes to generate a pruned set of travel routes, determining an optimal travel route for a transport among the pruned set of travel routes based on execution of a model optimization for a transportation network model that includes the pruned set of travel routes, and sending an instruction to utilize the optimal travel route to a computer associated with the transport.

Another example embodiment provides a computer system that may include a processor set, a set of one or more computer-readable storage media, and program instructions, collectively stored in the set of one or more storage media, that cause the processor set to perform computer operations that may include one or more of extracting multi-dimensional features of a set of travel routes between geographic locations, determining a first subset of travel routes that are valid and a second subset of travel routes that are invalid, among the travel routes based on execution of a first machine learning model on the multi-dimensional features, removing the second subset of travel routes from the travel routes to generate a pruned set of travel routes, determining an optimal travel route for a transport among the pruned set of travel routes based on execution of a model optimization for a transportation network model that includes the pruned set of travel routes, and sending an instruction to utilize the optimal travel route to a computer associated with the transport.

A further example embodiment provides a computer program product that may include a set of one or more computer-readable storage media, and program instructions, collectively stored in the set of one or more computer-readable storage media, for causing a processor set to perform computer operations that may include one of more of extracting multi-dimensional features of a set of travel routes between geographic locations, determining a first subset of travel routes that are valid and a second subset of travel routes that are invalid, among the travel routes based on execution of a first machine learning model on the multi-dimensional features, removing the second subset of travel routes from the travel routes to generate a pruned set of travel routes, determining an optimal travel route for a transport among the pruned set of travel routes based on execution of a model optimization for a transportation network model that includes the pruned set of travel routes, and sending an instruction to utilize the optimal travel route to a computer associated with the transport.

### BRIEF DESCRIPTION OF THE DRAWINGS

FIG. 1 is a diagram illustrating a computing environment according to an embodiment of the instant solution.

FIG. 2 is a diagram illustrating a system for pre-pruning routes and generating optimal routing instructions according to examples and features of the instant solution.

FIG. 3A is a diagram illustrating a process of extracting multi-dimensional features from input data according to examples and features of the instant solution.

FIG. 3B is a diagram illustrating a process of pre-pruning routes from among existing routes according to examples and features of the instant solution.

FIG. 3C is a diagram illustrating a process of generating routing instructions according to examples and features of the instant solution.

FIG. 3D is a diagram illustrating a process of dispatching routing instructions to a group of transports according to the examples and features of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

Routing software can be used to determine an “optimal” route for different modes of transport (e.g., vehicles, boats, planes, etc.) for distributing goods within a transportation network. The transportation network may include manufacturers (e.g., where products are manufactured), distribution centers (where products are aggregated and stored until needed), dealers (e.g., who sell products to stores, merchants, and other dealers), and the like. However, the software has a number of drawbacks. As an example, in many instances, there are too many pre-planned routes being considered which results in too many variables involved in the algorithm (optimization stage). Furthermore, too many pre-planned routes result in too many constraints on the algorithm. Furthermore, the complexity of the optimization stage is high resulting in reduced solution efficiency and slow processing times.

A recent study found that there are often many invalid routes that do not work for the optimal solution between a distribution center (DC) and a dealer. As referred to herein, an “invalid” route refers to a route that should not be used for various reasons; for example, routes that are physically possible but do not contribute effectively to an optimized solution. These routes may be logistically inefficient because they have high associated costs or longer lead times than alternatives. As another example, the invalid routes may be non-contributory in terms of demand, such as routes from specific plants that are not relevant. These routes might technically exist but are unlikely to be used in the optimal solution for the logistics model, so identifying and removing them early reduces unnecessary variables and constraints. However, typically, these routes are part of the pool of pre-planned routes that are considered by an optimization process, even though they are not likely to be useful to the transports.

The example embodiments are directed to a machine-learning system that is able to “pre-prune” invalid routes from the pool of pre-planned routes prior to the optimization process, thereby significantly improving the performance of the software and the accuracy of the optimization. For example, by reducing the number of routes considered by the optimization stage, the computer processing the optimization stage can need fewer computer cycles (greater processing speed) to produce an optimization recommendation because fewer routes are considered by the optimization stage. Furthermore, the complexity of the problem that needs to be optimized by the optimization stage is reduced significantly by reducing the number of routes considered, resulting in a more accurate and efficient optimization of the routes.

According to various embodiments, multivariate features (referred to herein as multi-dimensional features) are used to construct a deep learning classification model that can be used for pre-pruning the pre-planned routes to improve the optimization process. Pruning invalid routes in advance can reduce the number of variables and constraints that are considered by the optimized model, thereby reducing the complexity of the optimization problem, and increasing the accuracy of the resulting optimized routes. The deep learning pre-pruning model can improve the generalization of pruning and prevent the occurrence of invalid pruning. The multi-layer use of the pre-pruning model can greatly reduce the complexity of the subsequent optimization stage and improve optimization efficiency.

The example embodiments are directed to a system that provides a practical application to existing routing software. For example, the system can reduce the complexity of the optimization stage because the pre-pruning model (e.g., a deep neural network (DNN)-based classification model, etc.) identifies and eliminates invalid routes between entities such as distribution centers and dealers before the optimization stage is executed. This pre-pruning process removes unnecessary variables and constraints, simplifying the model structure. As a result, the optimization stage is less complex, thereby making it more computationally efficient.

In addition, the system provides an enhanced solution speed (processing speed) by reducing the number of routes and associated constraints in the model. The computational demand for solving the optimization stage decreases significantly. Further, the system enables lower memory and CPU usage in comparison to execution of traditional optimization models which must handle a large number of variables and constraints without any pre-pruning, leading to high computational complexity and resource usage. Pre-pruning invalid routes before they are introduced into the optimization model reduces the number of active variables and constraints that need processing. This, in turn, minimizes the memory and processing bandwidth required for computation. Compared to traditional routing models that include all potential routes regardless of their relevance, this method saves considerable computational resources.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

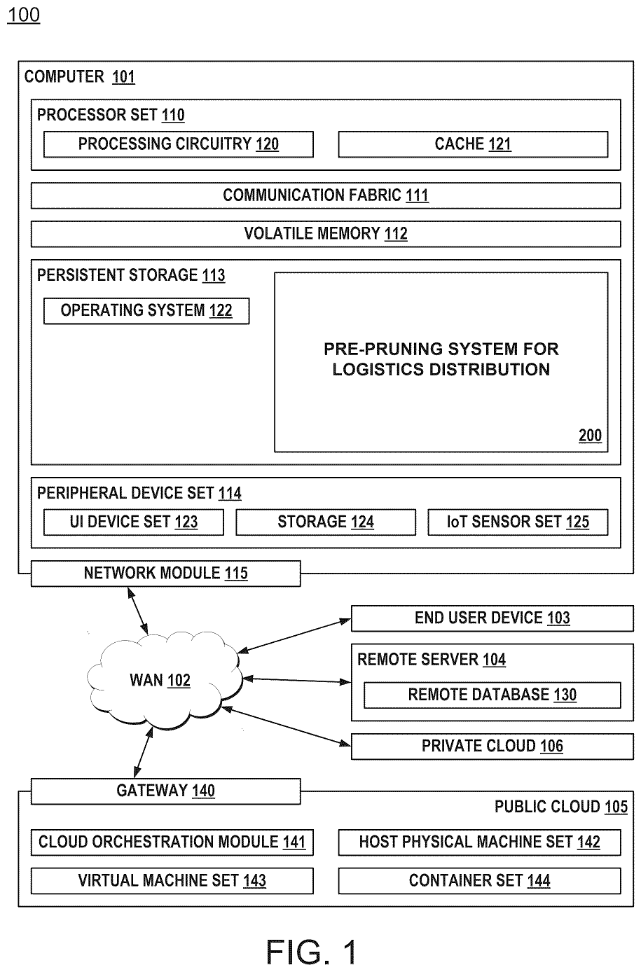

Referring to FIG. 1, computing environment 100 contains an example of an environment for the execution of at least some of the computer code involved in performing the inventive methods, such as pre-pruning system for logistics distribution 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

According to various embodiments, the system may extract a plurality of multi-dimensional features of a set of travel routes between a plurality of geographic locations. The system may determine a first subset of travel routes that are valid and a second subset of travel routes that are invalid, among a group of pre-planned/existing travel routes based on execution of a first computer model (e.g., a DNN, etc.) on the plurality of multi-dimensional features. The system may remove the second subset of travel routes from the travel routes to generate a pruned set of travel routes. The system may determine an optimal travel route for a transport among the pruned set of travel routes based on execution of a second computer model applied to the pruned set of travel routes. Furthermore, the system may send instructions to utilize the optimal travel route to a computing system associated with the transport.

The first computer model may be a classification model or neural network which generates a binary value with respect to each travel route among the set of travel routes based on the execution of the model on the plurality of multi-dimensional features. The binary value may indicate whether or not the travel route is valid (e.g., valid=1, and invalid=0, etc.) The system may remove the second subset of travel routes based on binary values assigned to the second subset of travel routes. In some embodiments, the system may train the neural network to determine the binary value based on historical routes, features of the historical routes, and labels assigned to the historical routes indicating whether the historical routes are valid or invalid.

In some embodiments, the system may retrieve attributes of the set of travel routes including at least one of available modes of transportation, distances between the plurality of geographic locations, lead times at the plurality of geographic locations, and the like, to determine the second subset of travel routes that are invalid by executing the neural network on the attributes of the set of travel routes. In some embodiments, the system may generate a table which includes route data of the set of travel routes, and the system may delete route data of the second subset of travel routes (invalid routes) from the table to generate a pruned table, and input the pruned table into a second computer model such as an optimization model.

In some embodiments, the system may determine the second subset of travel routes that are invalid by determining travel routes that are unlikely to be used based on at least one of route attributes, geographic locations on the travel routes, and lead times at the geographic locations through execution of the first computer model. In some embodiments, the system may extract the plurality of multi-dimensional features by extracting multiple features of a travel route among the set of travel routes and converting the multiple features into a vector to generate a multi-feature of the travel route.

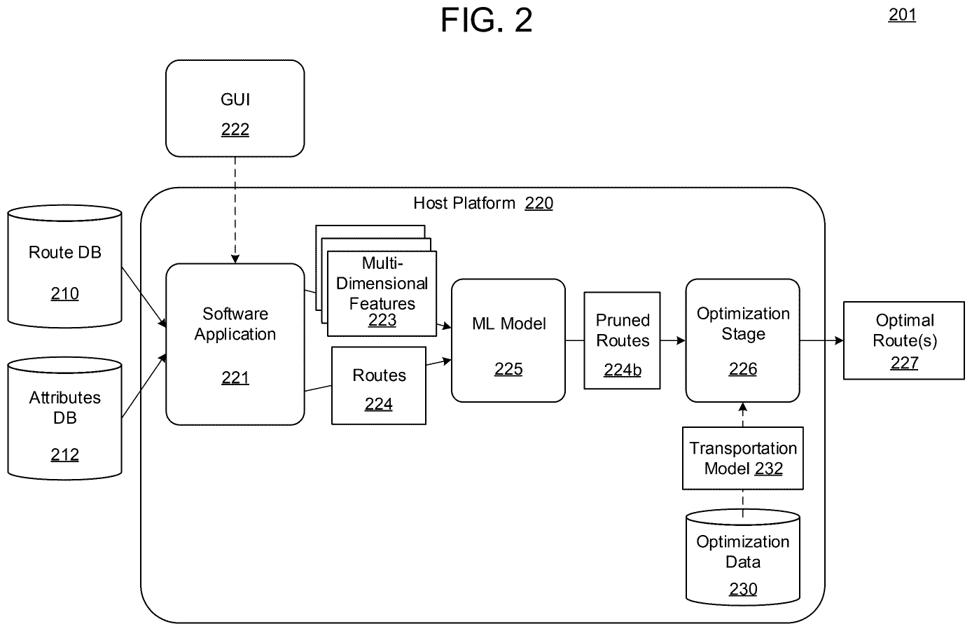

FIG. 2 illustrates a system 201 for pre-pruning routes and generating optimal routing instructions according to examples and features of the instant solution. For example, the system may include a software application 221 that can facilitate the pre-pruning of routes and the optimized route planning on the remaining routes. Referring to FIG. 2, a host platform 220 hosts the software application 221. For example, the host platform 220 may be a cloud platform, a web server, a database, a distributed system, an on-premises server, and the like. In this example, the process may be initiated by a command entered and submitted from a graphical user interface (GUI) 222 of the software application 221. Here, a user may enter a command to perform an optimization process for a predetermined group of entities (e.g., distribution centers, dealers, manufacturers, etc.) by selecting or otherwise providing input in the form of a touch, cursor, keyboard command, etc. via the GUI 222, which triggers the optimization process to start.

In response to receiving the command, the software application 221 may retrieve a list, set, group, etc. of pre-planned routes between the predetermined group of entities from a route database 210. The pre-planned routes may be previously generated and stored in the route database 210, and may include travel routes between the predetermined group of entities. The travel routes include, for example, roadways, shipping lanes, airplane routes, and the like. In addition, the software application 221 may also retrieve real-time attributes of the routes from an attribute database 212. The attributes may include current traffic conditions, weather conditions, demands at locations, lead times at locations, available modes of transportation, and the like.

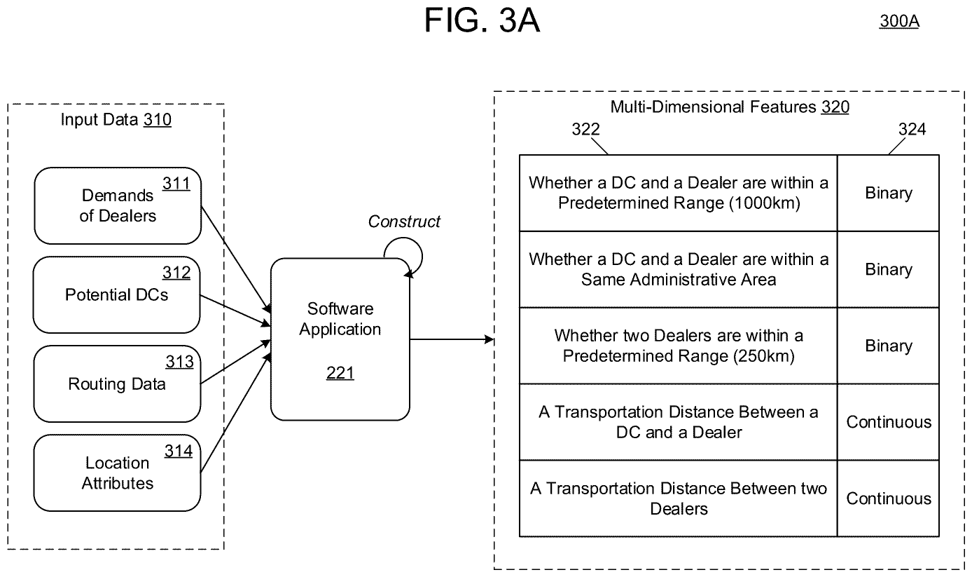

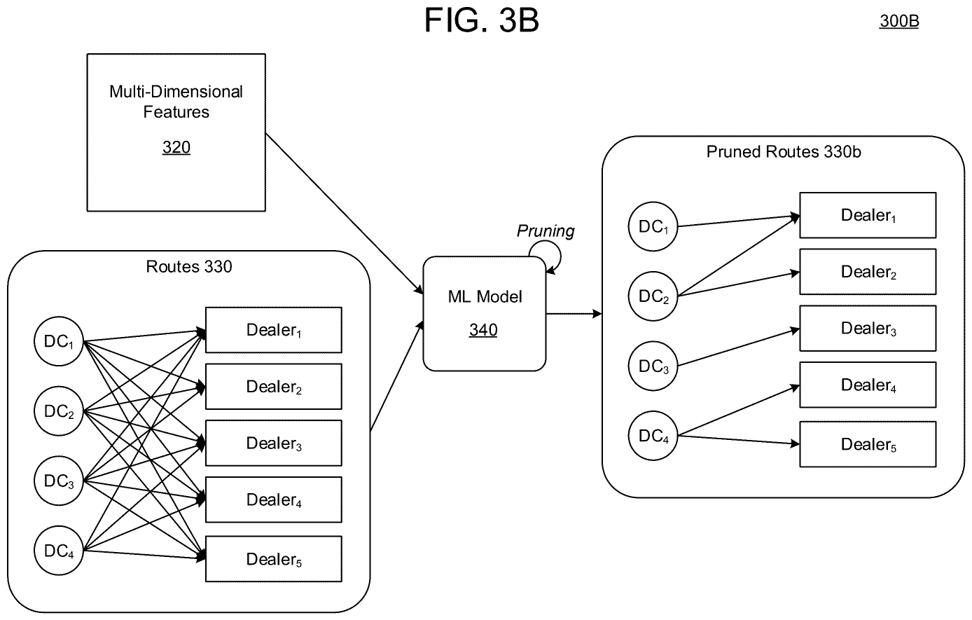

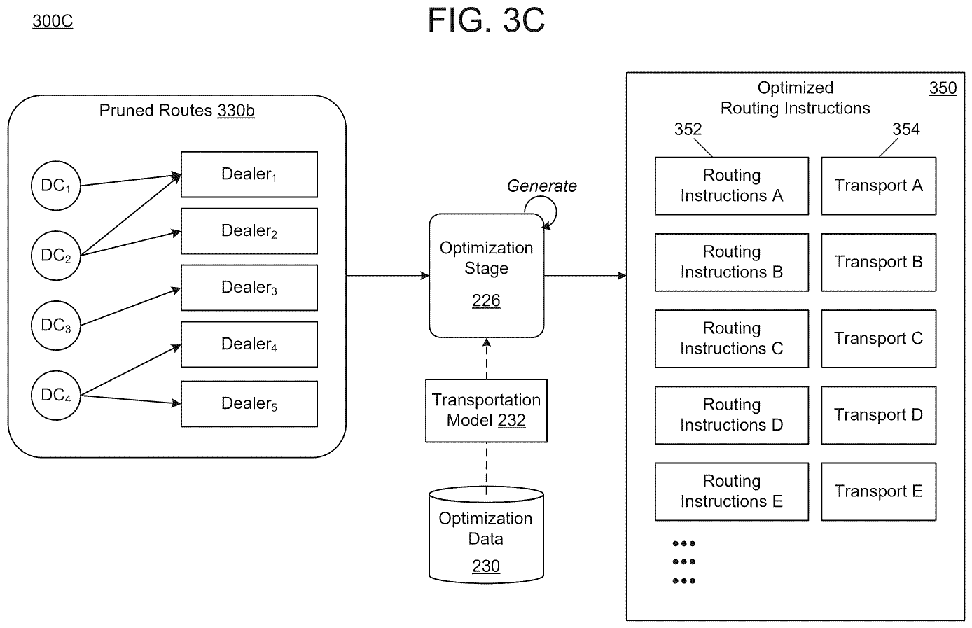

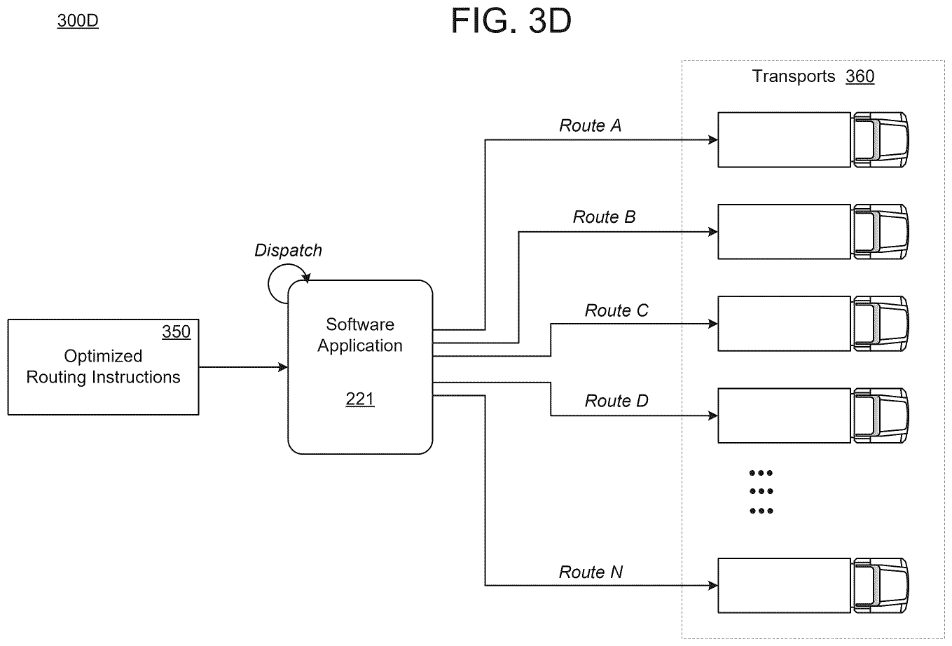

The software application 221 may generate multi-dimensional features 223 from the ingested route data and the attribute data. An example of generating multi-dimensional features 223 is further described with respect to FIG. 3A. The multi-dimensional features 223 and the pre-planned routes 224 may be input to a computer model such as a machine learning model 225. The machine learning model 225 may be a neural network, or the like, which can receive the pre-planned routes 224 and the multi-dimensional features 223 and prune invalid routes from the pre-planned routes 224 to generate the pruned routes 224b. Here, the machine learning model 225 may identify a first subset of routes among the pre-planned routes 224 that are valid and a second subset of routes among the pre-planned routes 224 that are invalid and remove the invalid routes from the pre-planned routes 224 to generate the pruned routes 224b.

According to various embodiments, the pruned routes 224b may be input into a transportation model optimization stage 226, which is configured to determine optimal routes 227 for transports that perform transport operations between the predetermined group of entities. For example, the transportation model optimization stage 226 may attempt to find the “optimal” routes for each transport to perform each task based on an objective function that attempts to optimize various aspects such as cost, travel time, number of transports needed, and the like. In some embodiments, the transportation model optimization stage 226 may also ingest a transportation model 232 from a transportation database 230 to determine the optimal routes. The transportation model 232 may contain a complete set of routes from which the pruned routes 227 are removed from. In some embodiments, the transportation model may include additional transportation/route attributes including goods to be delivered, types of available transports, and the like. The optimal routes 227 may include routing instructions from a starting location to a destination, for each transport, including tasks to be performed, goods to be shipped, times at which the trip is to start and end, etc.

FIG. 3A illustrates a process 300A of extracting features from input data according to examples and features of the instant solution. Referring to FIG. 3A, the software application 221 may ingest input data 310 for determining the optimal routing among entities in a transportation network such as manufacturers, distribution centers, dealers, sellers, and the like. The sources of input data 310 may vary.

The input data 310 may include the demands of the dealers 311, the basic attribute information of potential distribution centers 312, such as capacity, cargo throughput by different modes of transportation etc., which is maintained in the enterprise database, routing data 313 between the potential distribution centers, dealers, manufacturers, and the like, and location attributes 314 of the potential distribution centers, dealers, manufacturers, and the like. The software application 221 may access one or more data sources, for example, websites, databases, repositories, and the like, by calling an API associated therewith. In some embodiments, sale order related information may be obtained from enterprise sales database or by parsing a spreadsheet file, such as the demand of DC, the lead time of specified order, etc.

The software application 221 may construct multi-dimensional features 320 from the input data 310. The term “multi-dimensional features” reflects multiple features of transportation and/or logistics data, such as geographic proximity, administrative area similarity, transportation distance, transportation mode, and cost factors. Each feature is multi-dimensional because it accounts for various attributes that are used to represent the potential viability of each transportation route. In the example of FIG. 3A, each element of a multi-feature includes a definition 322 and a type 324 (e.g., continuous, binary, etc.). The use of multiple features may be used to construct appropriate multi-feature dimensions. In some embodiments, the software application 221 may extract the plurality of multi-dimensional features by extracting multiple features of a travel route among the set of travel routes and converting the multiple features into a vector to generate a multi-feature of the travel route. Therefore, the multi-dimensional features 320 may be in vector form.

Binary variables (0-1 features) simplify the problem by creating clear yes/no distinctions for factors such as whether two locations are within a certain distance or in the same administrative area. This use of binary distinctions reduces the complexity of the model. Continuous variables, while more precise (e.g., exact distances), are better suited for modeling the degree of a relationship (e.g., cost or time). However, binary variables are more effective for categorizing routes as valid/invalid for pruning, as they provide a simple, interpretable framework that aligns well with the goal of identifying and removing invalid routes from the transportation model optimization stage.

FIG. 3B illustrates a process 300B of pre-pruning routes from among existing routes 330 according to examples and features of the instant solution. Referring to FIG. 3B, the software application 221 may include a machine learning (ML) model 340 or may otherwise communicate with or be coupled to the ML model 340. The ML model 340 may be trained to identify “invalid” routes among the routes 330. The routes 330 may include a comprehensive set of all feasible routings, representing various paths between the group of predefined entities such as distribution centers (DCs), dealers, manufacturers, etc., as well as routes among multiple levels of dealers. The routes 330 may be input to the ML model 340 along with the multi-dimensional features 320 that are generated in the example of FIG. 3A.

In response, the ML model 340 may output a subset of valid routes and a subset of invalid routes. In these examples, an “invalid” route in this context does not refer to routes that are physically impossible but rather to those that do not contribute effectively to an optimized solution. These routes may be logistically inefficient, such as routes that have high associated costs or longer lead times than alternatives. As another example, the invalid routes may be non-contributory in terms of demand such as routes that do not align well with the transportation needs of the dealers, such as routes from specific manufacturing plants that are not relevant for certain dealers based on demand e.g., no demand for a product made by a particular manufacturer, etc. Although these routes might technically exist, they are unlikely to be used in the optimal solution for the logistics model, and identifying and removing them early reduces unnecessary variables and constraints. The output of the ML model 340 is a set of pruned routes 330b, which include the subset of valid routes 330 with the invalid routes removed. In some embodiments, the ML model 340 generates a contribution score for each of the input routes and the binary determination for a particular route is based on a respective contribution score for that route (A) exceeding a predetermined threshold value, (B) equaling or exceeding a predetermined threshold value, (C) not exceeding a predetermined threshold value, or (D) equaling or not exceeding a predetermined threshold value. FIG. 3B shows that there are fewer arrows in the pruned routes 330b compared to the number of arrows in the routes 330, because each arrow represents a particular route in a transportation network. This set of fewer arrows for the pruned routes 330b illustrates that pruning has taken place via the ML model 340 analysis and output.

In the example embodiments, to “prune” routes means to selectively remove certain routes from the transportation model optimization stage before any detailed calculations or constraints are set up in the optimization stage. The input to the ML model 340 may include the multi-dimensional features 320 which include multi-dimensional transportation and business features. These features represent characteristics such as the distance between DCs and dealers, whether DCs and dealers are in the same administrative region, cost and transportation modes associated with each route, etc. The output of the ML model 340 may be a binary decision for each route, where an output value of 1 indicates that a route is valid and should be retained for optimization, and an output value of 0 indicates that a route is invalid and should be pruned from the dataset, or vice versa. This binary output enables the pre-pruning process by determining whether each route should be included in the final model.

In some embodiments, the software application 221 may perform a training or re-training process for the ML model 340. The ML model 340 may be trained using supervised learning, where the goal is to classify routes as either valid or invalid for the transportation model optimization stage. The training data may include historical routing data with labeled examples of valid and invalid routes. Each instance in the training data is represented by a set of multiple features (e.g., distance, administrative area, transport mode), and the corresponding label (valid or invalid) is known in advance.

FIG. 3C illustrates a process 300C of generating a set of optimized routing instructions 350 according to examples and features of the instant solution. Referring to FIG. 3C, the pruned routes 330b generated by the ML model 340 may be output by the ML model 340 and input to a transportation model optimization stage 226. Here, a script or other executable within the software application 221 may take the output from the ML model 340 and transfer it to the transportation model optimization stage 226. Furthermore, in some embodiments, the script may generate a table which includes route data of the set of travel routes, and the script may delete route data of the invalid routes from the table to generate a pruned table and input the pruned table into the transportation model optimization stage.

The transportation model optimization stage 226 may generate the set of optimized routing instructions 350 for a group of transports. Each optimized routing instruction may include routing instructions 352 (e.g., how to navigate from a starting point to a destination, a mode of transportation, a time to start, goods to carry, etc.) and an identifier of a transport 354 to which the routing instructions 352 are assigned. In addition to the pruned routes 330b, a transportation model 232 that in various embodiments includes one or more variables and optionally one or more constraints is also input into the transportation model optimization stage 226. In the transportation model optimization stage 226, the pruned routes 330b are analyzed together with the transportation model 344 that is input.

The transportation model 232 includes a mathematical model that includes multiple variables and an objective function. The variables in various embodiments may include components such as particular components/goods to be delivered, types (e.g., trucks, semi-trucks, cars, trailers, vans, cargo ships, train cars, planes, etc.) and number of transports that are available, etc. Performing the model optimization operation in the transportation model optimization stage 226 includes determining an optimal combination of values for these multiple variables that minimizes or maximizes the particular objective function. For example, in some embodiments, performing the model optimization operation includes determining values for variables so as to minimize a total cost function for transporting products across a transportation network. In some embodiments, the model optimization operation may include one or more constraints. For example, in some embodiments, the model optimization operation may include constraints defining the various requirements of component recipients. Thus, performing the model optimization operation may include determining values for variables based on some objective function while satisfying one or more constraints.

In order to reduce the overall transportation cost, multiple DCs may be established, but in the process of establishing DCs, there are certain business limitations, such as the capacity of a DC that cannot exceed a certain threshold, and the like. However, if the business scenario changes, the corresponding constraints may also be dynamically changed. The pruned routes can be used to generate an optimal solution such as which routes need to be optimized, what are the transportation modes that need to be optimized, and the output is the determined variable value, such as the final selection of specific transportation modes and transportation routes to achieve the goal (like total transportation cost) optimal purpose.

The transformation model optimization stage 226 for the transportation model may include an objective function to achieve the business purpose, for example, by determining the specific transportation mode and transportation route between different factories to different DCs, and between different DCs and different dealers, to achieve the ultimate total transportation cost optimization. Based on the transportation model optimization stage 226, the enterprise can assign tasks to the factory and DC based on the output results of the transportation model optimization stage 226, and the software application 221 can directly apply the transportation model optimization stage 226 for use in the development process, and finally give the optimal business solution, which must meet the optimal goal, such as the lowest transportation cost, and meet the business constraints, such as the capacity of some DCs must be within the threshold. As an example, the transportation model optimization stage 226 may analyze variables or constraints that are input including core business elements, such as the lowest cost corresponding to the objective, what kind of optimized solution is needed to achieve this goal, corresponding to the variables, and what are the business constraints in the process of pursuing the optimal solution, corresponding to the constraints.

FIG. 3D illustrates a process 300D of dispatching the tasks to a group of vehicles/crews based on the optimized routing instructions 350 according to the examples and features of the instant solution. Referring to FIG. 3D, the software application 221 may identify a subset of tasks to be dispatched to each transport among a set of transports 360 (which are semi-trucks in the depiction), and routes on which the subset of tasks are to be performed. The software application 221 may send instructions to each of the transports in the set of transports 360 with the routing instructions, task identifiers, time periods, and the like. For example, the software application 221 may display the routing instructions on a navigation system, infotainment system, etc. of the transports in the set of transports 360.

In some embodiments, the instructions that are provided from the software application 221 to the transports may include routing instructions for autonomous vehicles, including geographic routes on which the vehicles should travel to arrive at each of the tasks, in an order in which the tasks are assigned, etc. For example, the routes may include optimal travel routes between a distribution center, a dealer, a manufacturer, and the like. The routing instructions may be sent to the transports directly, for example, to navigation systems/application installed within computer systems of the transports. As another example, the routing instructions may be sent to a computing system, such as a server associated with the transports, which then forwards the instructions to the transports.

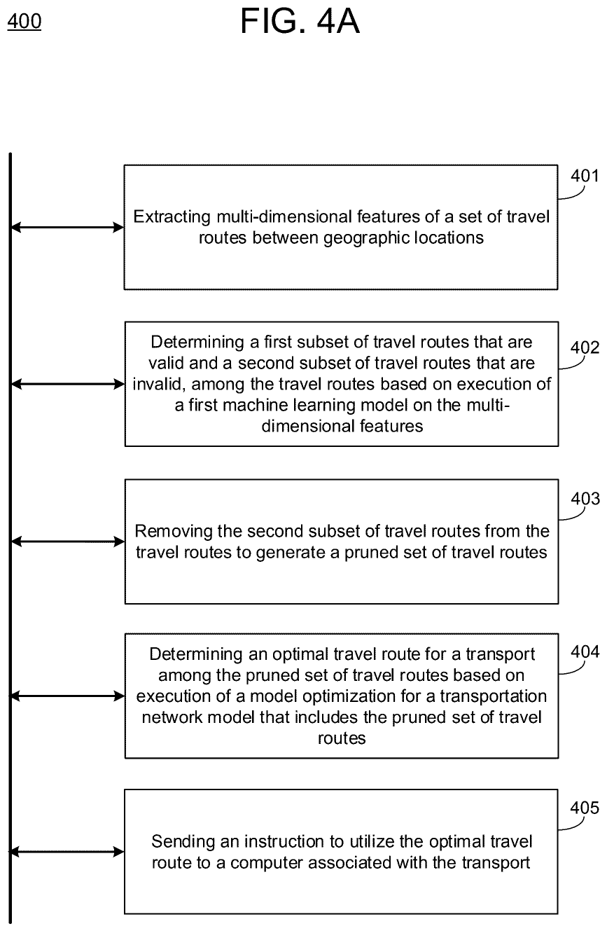

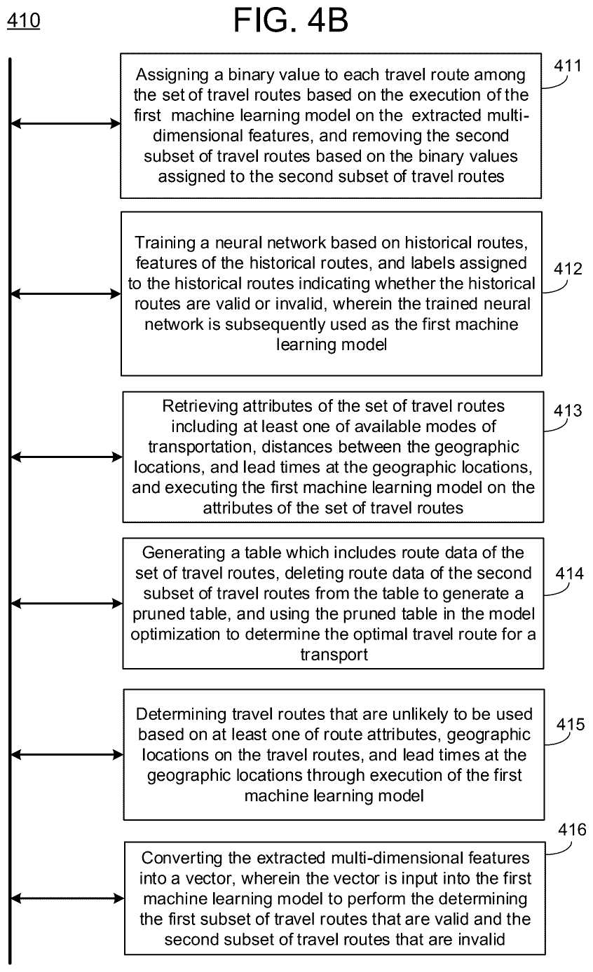

FIG. 4A illustrates a flow diagram of a method 400, according to example embodiments. Referring to FIG. 4A, in 401, the method may include extracting multi-dimensional features of a set of travel routes between geographic locations. In 402, the method may include determining a first subset of travel routes that are valid and a second subset of travel routes that are invalid, among the travel routes based on execution of a first machine learning model on the multi-dimensional features. In 403, the method may include removing the second subset of travel routes from the travel routes to generate a pruned set of travel routes. In 404, the method may include determining an optimal travel route for a transport among the pruned set of travel routes based on execution of a model optimization for a transportation network model that includes the pruned set of travel routes. In 405, the method may include sending an instruction to utilize the optimal travel route to a computer associated with the transport.

FIG. 4B illustrates a flow diagram of a method 410, according to example embodiments. Referring to FIG. 4B, in 411, the method may include assigning a binary value to each travel route among the set of travel routes based on the execution of the first machine learning model on the extracted multi-dimensional features, and removing the second subset of travel routes based on the binary values assigned to the second subset of travel routes. In 412, the method may include training a neural network based on historical routes, features of the historical routes, and labels assigned to the historical routes indicating whether the historical routes are valid or invalid, wherein the trained neural network is subsequently used as the first machine learning model for the determining of the first subset of travel routes that are valid and the second subset of travel routes that are invalid.

In 413, the method may include retrieving attributes of the set of travel routes including at least one of available modes of transportation, distances between the geographic locations, and lead times at the geographic locations, and executing the first machine learning model on the attributes of the set of travel routes. In 414, the method may include generating a table which includes route data of the set of travel routes, wherein the removing comprises deleting route data of the second subset of travel routes from the table to generate a pruned table, and using the pruned table in the model optimization to determine the optimal travel route for a transport.

In 415, the method may include determining travel routes that are unlikely to be used based on at least one of route attributes, geographic locations on the travel routes, and lead times at the geographic locations through execution of the first machine learning model. In 416, the method may include converting the extracted multi-dimensional features into a vector, wherein the vector is input into the first machine learning model to perform the determining the first subset of travel routes that are valid and the second subset of travel routes that are invalid.

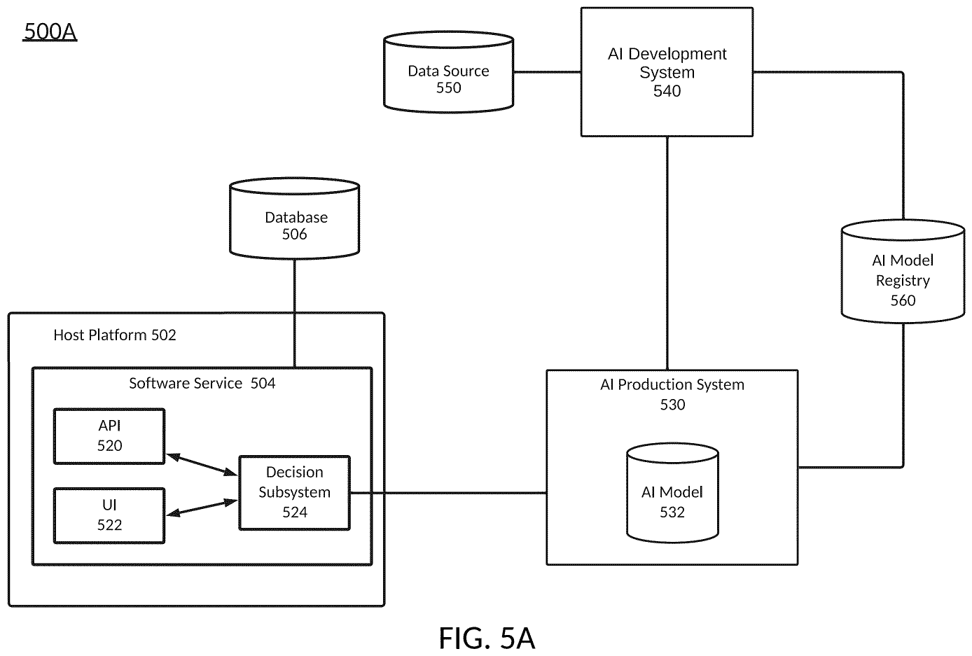

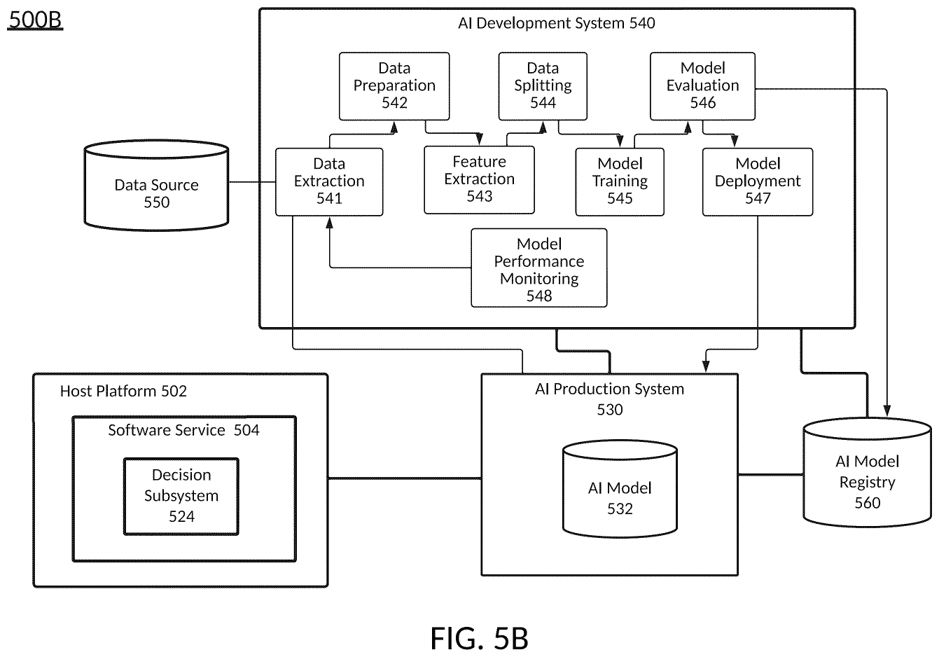

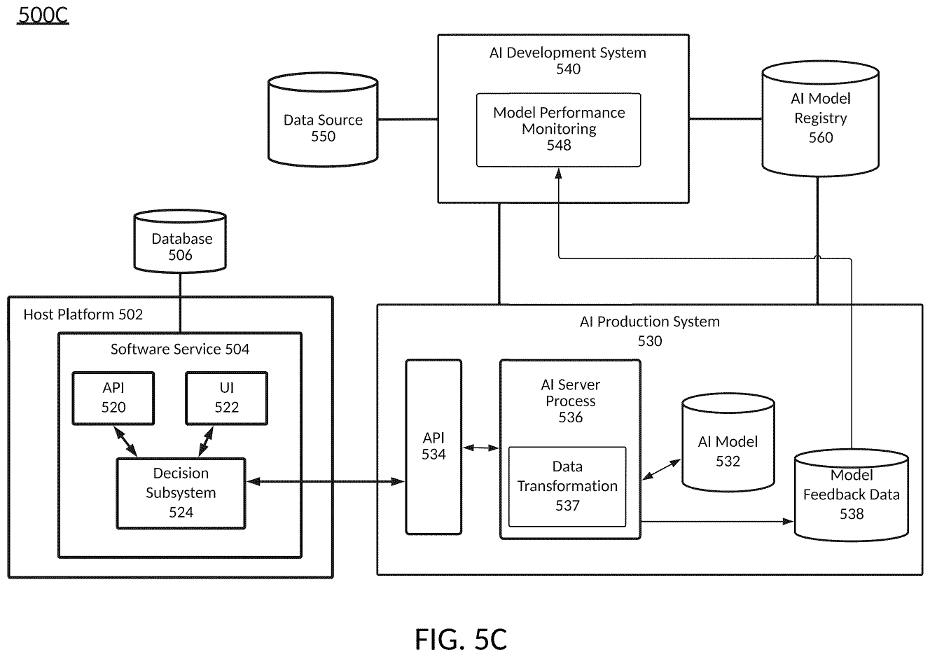

Detailed descriptions of training a machine learning model and executing a machine learning model are further described and depicted herein. The training and execution of the machine learning model described in the examples of FIGS. 5A-5C may be performed inside a confidential machine learning computing environment as described in the examples herein.

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies, and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI models refer to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content - such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive one car, for example, and without too much effort, could learn how to drive other types of vehicles such as other cars, a truck, or a bus. The foundation model is similarly used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks, and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx. ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks, and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer-readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
extracting multi-dimensional features of a set of travel routes between geographic locations;
determining a first subset of travel routes that are valid and a second subset of travel routes that are invalid, among the travel routes based on execution of a first machine learning model on the multi-dimensional features;
removing the second subset of travel routes from the travel routes to generate a pruned set of travel routes;
determining an optimal travel route for a transport among the pruned set of travel routes based on execution of a model optimization for a transportation network model that includes the pruned set of travel routes; and
sending an instruction to utilize the optimal travel route to a computer associated with the transport.

2. The computer-implemented method of claim 1, further comprising assigning a binary value to each travel route among the set of travel routes based on the execution of the first machine learning model on the extracted multi-dimensional features, wherein the removing comprises removing the second subset of travel routes based on the binary values assigned to the second subset of travel routes.

3. The computer-implemented method of claim 1, further comprising training a neural network based on historical routes, features of the historical routes, and labels assigned to the historical routes indicating whether the historical routes are valid or invalid, wherein the trained neural network is subsequently used as the first machine learning model for the determining of the first subset of travel routes that are valid and the second subset of travel routes that are invalid.

4. The computer-implemented method of claim 1, further comprising retrieving attributes of the set of travel routes including at least one of available modes of transportation, distances between the geographic locations, and lead times at the geographic locations, wherein the determining the second subset of travel routes that are invalid further comprises executing the first machine learning model on the attributes of the set of travel routes.

5. The computer-implemented method of claim 1, further comprising generating a table which includes route data of the set of travel routes, wherein the removing comprises deleting route data of the second subset of travel routes from the table to generate a pruned table, and using the pruned table in the model optimization to determine the optimal travel route for a transport.

6. The computer-implemented method of claim 1, wherein the determining the second subset of travel routes that are invalid comprises determining travel routes that are unlikely to be used based on at least one of route attributes, geographic locations on the travel routes, and lead times at the geographic locations through execution of the first machine learning model.

7. The computer-implemented method of claim 1, further comprising converting the extracted multi-dimensional features into a vector, wherein the vector is input into the first machine learning model to perform the determining the first subset of travel routes that are valid and the second subset of travel routes that are invalid.

8. A computer system comprising:
a processor set;
a set of one or more computer-readable storage media; and
program instructions, collectively stored in the set of one or more storage media, that cause the processor set to perform computer operations comprising:
extracting multi-dimensional features of a set of travel routes between geographic locations;
determining a first subset of travel routes that are valid and a second subset of travel routes that are invalid, among the travel routes based on execution of a first machine learning model on the multi-dimensional features;
removing the second subset of travel routes from the travel routes to generate a pruned set of travel routes;
determining an optimal travel route for a transport among the pruned set of travel routes based on execution of a model optimization for a transportation network model that includes the pruned set of travel routes; and
sending an instruction to utilize the optimal travel route to a computer associated with the transport.

9. The computer system of claim 8, wherein the computer operations further comprise assigning a binary value to each travel route among the set of travel routes based on the execution of the first machine learning model on the extracted multi-dimensional features, wherein the removing comprises removing the second subset of travel routes based on the binary values assigned to the second subset of travel routes.

10. The computer system of claim 8, wherein the computer operations further comprise training a neural network based on historical routes, features of the historical routes, and labels assigned to the historical routes indicating whether the historical routes are valid or invalid, wherein the trained neural network is subsequently used as the first machine learning model for the determining of the first subset of travel routes that are valid and the second subset of travel routes that are invalid.

11. The computer system of claim 8, wherein the computer operations further comprise retrieving attributes of the set of travel routes including at least one of available modes of transportation, distances between the geographic locations, and lead times at the geographic locations, wherein the determining the second subset of travel routes that are invalid further comprises executing the first machine learning model on the attributes of the set of travel routes.

12. The computer system of claim 8, wherein the computer operations further comprise generating a table which includes route data of the set of travel routes, wherein the removing comprises deleting route data of the second subset of travel routes from the table to generate a pruned table, and using the pruned table in the model optimization to determine the optimal travel route for a transport.

13. The computer system of claim 8, wherein the determining the second subset of travel routes that are invalid comprises determining travel routes that are unlikely to be used based on at least one of route attributes, geographic locations on the travel routes, and lead times at the geographic locations through execution of the first machine learning model.

14. The computer system of claim 8, wherein the computer operations further comprise converting the extracted multi-dimensional features into a vector, wherein the vector is input into the first machine learning model to perform the determining the first subset of travel routes that are valid and the second subset of travel routes that are invalid.

15. A computer program product comprising:
a set of one or more computer-readable storage media; and
program instructions, collectively stored in the set of one or more computer-readable storage media, for causing a processor set to perform computer operations comprising:
extracting multi-dimensional features of a set of travel routes between geographic locations;
determining a first subset of travel routes that are valid and a second subset of travel routes that are invalid, among the travel routes based on execution of a first machine learning model on the multi-dimensional features;
removing the second subset of travel routes from the travel routes to generate a pruned set of travel routes;
determining an optimal travel route for a transport among the pruned set of travel routes based on execution of a model optimization for a transportation network model that includes the pruned set of travel routes; and
sending an instruction to utilize the optimal travel route to a computer associated with the transport.

16. The computer program product of claim 15, wherein the computer operations further comprise assigning a binary value to each travel route among the set of travel routes based on the execution of the first machine learning model on the extracted multi-dimensional features, wherein the removing comprises removing the second subset of travel routes based on the binary values assigned to the second subset of travel routes.

17. The computer program product of claim 15, wherein the computer operations further comprise training a neural network based on historical routes, features of the historical routes, and labels assigned to the historical routes indicating whether the historical routes are valid or invalid, wherein the trained neural network is subsequently used as the first machine learning model for the determining of the first subset of travel routes that are valid and the second subset of travel routes that are invalid.

18. The computer program product of claim 15, wherein the computer operations further comprise retrieving attributes of the set of travel routes including at least one of available modes of transportation, distances between the geographic locations, and lead times at the geographic locations, wherein the determining the second subset of travel routes that are invalid further comprises executing the first machine learning model on the attributes of the set of travel routes.

19. The computer program product of claim 15, wherein the computer operations further comprise generating a table which includes route data of the set of travel routes, wherein the removing comprises deleting route data of the second subset of travel routes from the table to generate a pruned table, and using the pruned table in the model optimization to determine the optimal travel route for a transport.

20. The computer program product of claim 15, wherein the determining the second subset of travel routes that are invalid comprises determining travel routes that are unlikely to be used based on at least one of route attributes, geographic locations on the travel routes, and lead times at the geographic locations through execution of the first machine learning model.
